(19) United States
(12) Patent Application Publication
(10) Pub. No.: US 2011/0063196 A1
(43) Pub. Date: Mar. 17, 2011

(54) ELECTRONIC PAPER DISPLAY DEVICE AND MANUFACTURING METHOD THEREOF

(75) Inventors: Jeong Bok KWAK, Suwon (KR); Hwan-Soo LEE, Seoul (KR); Young Woo LEE, Suwon (KR); Sang Moon LEE, Seoul (KR)

(73) Assignee: SAMSUNG ELECTRO-MECHANICS CO., LTD., Suwon (KR)

(21) Appl. No.: 12/643,828

(22) Filed: Dec. 21, 2009

(30) Foreign Application Priority Data
Sep. 14, 2009 (KR) 10-2009-0086607

(51) Int. Cl. G09G 3/30; H01J 9/00

(52) U.S. Cl. 345/76; 445/24

(57) ABSTRACT

There is provided an electronic paper display device and a manufacturing method thereof. The electronic paper display device includes a first substrate formed of a light transmitting material; a second substrate disposed to face the first substrate having a predetermined gap therebetween; at least one or more rotatable balls disposed between the first and second substrates and having electrical and optical anisotropy; and partitions dividing a space between the first and second substrates into a plurality of cell spaces accommodating the rotatable balls. The partitions are disposed to be spaced apart from each other with differing gaps therebetween in order to allow the cell spaces to have different sizes. When the same magnitude of voltage is applied to the rotatable balls disposed in the differently sized cell spaces, respective rotation angles of the rotatable balls become different, and accordingly a wide range of contrast levels is displayed.

### CROSS-REFERENCE TO RELATED APPLICATIONS

This application claims the priority of Korean Patent Application No. 10-2009-0086607 filed on Sep. 14, 2009, in the Korean Intellectual Property Office, the disclosure of which is incorporated herein by reference.

### BACKGROUND OF THE INVENTION

1. Field of the Invention

The present invention relates to an electronic paper display device and a manufacturing method thereof, and more particularly, to an electronic paper display device capable of achieving excellent stability and uniformity of an image and the facilitation of contrast adjustment and a manufacturing method thereof.

2. Description of the Related Art

In recent years, changes in the way information is transferred and shared have been required to keep pace with an information society in which a new paradigm is required. In order to satisfy such a requirement, the development of electronic paper capable of being bent as a flexible display has been accelerated, and thus the technological development of electronic paper is now entering a commercially viable stage.

In comparison with an existing flat display panel, electronic paper offers lower manufacturing costs and superior energy efficiency in view of the fact that since electronic paper does not require background lighting or constant recharging, it can be driven even with very little energy. Also, electronic paper is very vivid and has a wide viewing angle. Moreover, electronic paper has a memory function allowing for the retention of characters even without power. These advantages allow for a wide range of electronic paper applications, such as an electronic book having a paper-like appearance and including moving illustrations, a renewable newspaper, a reusable paper display for a mobile phone, a disposable TV screen, or electronic wallpaper. Electronic paper therefore has huge market potential.

Proposed technical methods for the realization of electronic paper are divided into four approaches: a twist ball method allowing for the rotation of spherical particles having oppositely electrically charged upper and lower hemispheres of different colors by using an electric field; an electrophoretic method of keeping charged pigment particles mixed with oil in a microcapsule or a microcup and applying an electric field thereto or allowing the charged particles to respond to the application of an electric field; a Quick Response-Liquid Powder Display (QR-LPD) method using a charged liquid powder; or a Cholesteric-Liquid Crystal Display (Ch-LCD) method using selective reflection of cholesteric liquid crystal molecules.

According to the twist ball method, a cell is filled with a transparent medium, and a twist ball having opposite electric charges and different colors, for example, a twist ball hemispherically colored black and white is disposed in the transparent medium. When voltage is applied to the twist ball, the twist ball rotates such that the hemisphere having a polarity opposite to that of the applied voltage is positioned toward the front side of a display according to direction of the applied voltage, and thus black or white can be displayed.

In this structure, however, since voltage is applied from upper and lower transparent electrodes disposed on the top and bottom of the cell, the twist ball rotates while allowing charged states to be balanced in a parallel manner according to the direction of the applied voltage. Accordingly, only two colors, i.e. black and white, are displayed, so there is a limitation in the display of contrast levels.

### SUMMARY OF THE INVENTION

An aspect of the present invention provides an electronic paper display device capable of achieving a wide range of contrast levels by controlling the rotation amount of rotatable balls and a manufacturing method thereof.

According to an aspect of the present invention, there is provided an electronic paper display device, the electronic paper display device including: a first substrate formed of a light transmitting material; a second substrate disposed to face the first substrate having a predetermined gap therebetween; at least one or more rotatable balls disposed between the first and second substrates and having electrical and optical anisotropy; and partitions dividing a space between the first and second substrates into a plurality of cell spaces accommodating the rotatable balls. The partitions may be disposed to be spaced apart from each other with differing gaps therebetween in order to allow the cell spaces to have different sizes.

The cell spaces may have a shape of a polyhedron, a sphere, or a cylinder.

The first and second substrates may have first and second electrodes formed thereon in order to apply voltage to the rotatable balls.

The partitions may be integrated with the second substrate.

The rotatable balls may have two display areas having different colors and different electrical charge properties.

The rotatable balls may have a shape of a sphere, an oval-shaped sphere or a cylinder.

The cell spaces may be filled with dielectric liquid.

Two or more of the cell spaces having different sizes may be repeatedly formed. Two or more of the cell spaces having different sizes and two or more of the rotatable balls disposed therein may form a single pixel.

According to another aspect of the present invention, there is provided a method of manufacturing an electronic paper display device, the method including: preparing a first substrate formed of a light transmitting material; forming partitions dividing a space on the first substrate into a plurality of cell spaces and having differing gaps therebetween in order to allow the cell spaces to be formed to have different sizes; disposing rotatable balls in the respective cell spaces, the cell spaces having electrical and optical anisotropy; and attaching a second substrate in order to cover the rotatable balls provided on the first substrate.

The partitions may be integrated with the first substrate. The partitions may be formed by implanting, laser patterning, photolithography, or etching.

The method may further include forming first and second electrodes on the first and second substrates.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating an electronic paper display device according to an exemplary embodiment of the present invention;

FIG. 2 is a perspective view illustrating an enlarged rotatable ball according to an exemplary embodiment of the present invention;

FIG. 3 is a schematic plan view illustrating an electronic paper display device according to an exemplary embodiment of the present invention; and

FIGS. 4 through 6 are cross-sectional views illustrating a method of manufacturing an electronic paper display device according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

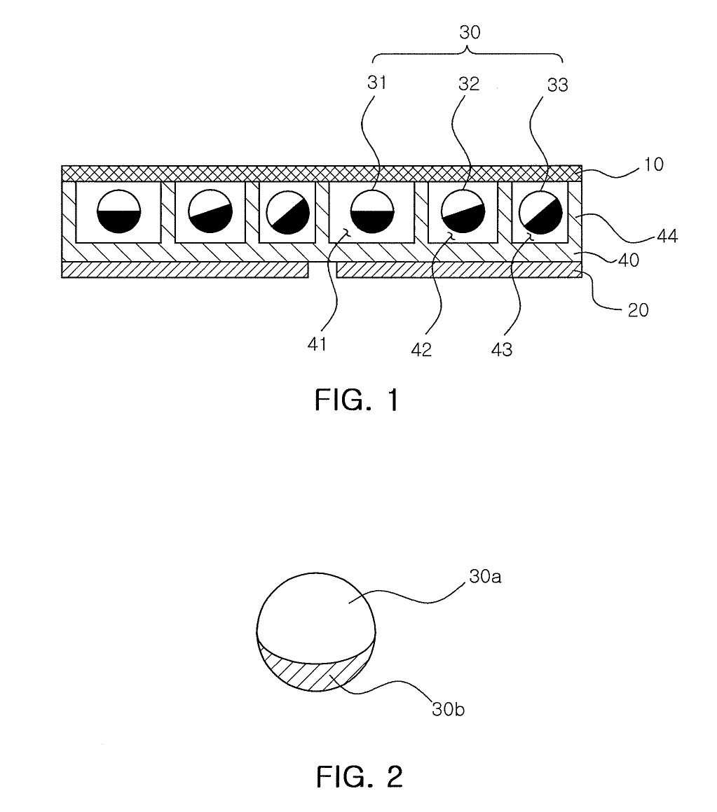

FIG. 1 is a schematic cross-sectional view illustrating an electronic paper display device according to an exemplary embodiment of the present invention. Referring to FIG. 1, an electronic paper display device according to the present embodiment includes a first substrate 10, a second substrate 40, rotatable balls 30, and partitions 44 providing a plurality of cell spaces 41, 42 and 43 where the rotatable balls are accommodated. The partitions 44 are arranged to be spaced apart from each other with differing gaps therebetween in order that the cell spaces are formed to have different sizes.

The electronic paper display device according to this embodiment includes the first and second substrates 10 and 40, in which the second substrate 40 is disposed to face the first substrate 10 having a predetermined gap therebetween.

The first and second substrates 10 and 40 may be formed of glass or flexible plastic. For example, the plastic may be polyethylene terephthalate (PET), polycarbonate (PC), polymethylmethacrylate (PMMA), polyethylenenaphthalate (PEN), Polyethersulfone (PES), cycloolefin copolymer (COC), polydimethylsiloxane (PDMS), or poly urethane acrylate (PUA). However, the plastic is not limited thereto.

The first substrate 10 may be provided as a display surface. In order to be a display surface, the first substrate 10 may be formed of a light-transmitting material.

The first and second substrates 10 and 40 may have a first electrode (not shown) and a second electrode 20 formed thereon in order to apply voltage to the rotatable balls 30.

The first and second electrodes may be formed of a conductive material that has been commonly used in this technical field. For example, a conductive polymer such as polythiophene (PT) or polyaniline (PANI), metal particles such as silver or nickel, a polymer film including the metal particles, Indium-Tin-Oxide (ITO), or the like may be used therefor.

Also, in the first and second substrates 10 and 40, a control unit may be provided in order to control the magnitude and direction of voltage being applied to the rotatable balls.

The first and second substrates may have the plurality of partitions 44 formed therebetween. By the use of the partitions 44, the plurality of cell spaces 41, 42 and 43 are formed. The partitions 44 are arranged to be spaced apart from each other with differing gaps therebetween, thereby allowing the cell spaces to be formed to have different sizes. In this description, the spaces between the partitions are defined as “cell spaces.”

The shape of the cell spaces is not particularly limited. The shape thereof may be a polyhedron, a sphere, or a cylinder.

A material for the partitions 44 is not particularly limited so long as it has flexibility. A thermosetting resin or a UV-curable resin may be used therefor.

For example, polyethylene terephthalate (PET), polycarbonate (PC), polymethylmethacrylate (PMMA), polyethylenenaphthalate (PEN), Polyethersulfone (PES), cycloolefin copolymer (COC), polydimethylsiloxane (PDMS), or poly urethane acrylate (PUA) may be used therefor.

Also, the partitions 44 may be integrated with the second substrate 40.

Each of the cell spaces 41, 42 and 43 has the rotatable balls 31, 32 and 33 having electrical and optical anisotropy disposed therein, respectively. Also, the cell spaces may be filled with dielectric liquid in order to facilitate the rotation of the rotatable balls.

FIG. 2 is a schematic perspective view illustrating an enlarged rotatable ball. Referring to FIG. 2, the rotatable ball 30 has two display areas 30a and 30b having different colors and different electrical charge properties. The two display areas 30a and 30b may be differently colored in such a manner that a first display area 30a may be colored white and a second display area 30b may be colored black. When the first display area 30a is charged with a positive charge, the second display area 30b is charged with a negative charge. When voltage is applied to the rotatable ball 30, the rotatable ball 30 rotates according to the magnitude and direction of applied voltage, and thus black or white is displayed due to the coloring on the two display areas 30a and 30b.

In this case, a known method in the art may be used for processing the rotatable ball 30 electrically and optically to form the first and second display areas 30a and 30b. For example, there may be used a method of applying a centrifugal force to a rotatable ball provided to a rotatable disk including two coloring liquids.

The shape of the rotatable ball is not particularly limited. For example, the shape thereof may be a sphere, an oval-shaped sphere or a cylinder.

In the present embodiment, the rotatable ball 30 has two display areas formed on the surface thereof. However, the number of display areas may be three or more, if desired.

Also, the display areas may be colored a variety of colors other than black or white.

The first and second substrates 10 and 40 may have the first and second electrodes formed thereon in order to apply voltage to the rotatable balls 30. Through the first and second electrodes, voltage is applied to the rotatable balls 30. The rotatable balls 30 may rotate while allowing charged states to be balanced in a parallel manner according to the direction of the applied voltage, and black or white is displayed accordingly.

According to the present embodiment, each of the cell spaces 41, 42 and 43, in which the rotatable balls 31, 32 and 33 are respectively disposed, has a different size. Accordingly, when the same magnitude of voltage is applied to the rotatable balls 31, 32 and 33 disposed in the differently sized cell spaces, respective rotation amounts of the rotatable balls, i.e., respective rotation angles thereof become different.

This is because as the size of cell spaces is reduced, resistance that is felt by rotatable balls during rotation is increased. That is, as the size of cell spaces becomes larger, the resistance applied to rotatable balls is smaller, whereby the rotation amount of the rotatable balls increases, and consequently the rotation angle becomes greater. In contrast, as the size of cell spaces becomes smaller, the resistance applied to rotatable balls is greater, whereby the rotation amount of the rotatable balls reduces, and consequently the rotation angle is reduced.

More particularly, as shown in FIG. 1, a sequence of three differently sized cell spaces 41, 42 and 43 may be repeatedly formed. Here, the size of the cell spaces is 41>42>43.

When the same magnitude of voltage is applied, a first rotatable ball 31 disposed in the largest cell space 41 has the greatest degree of rotation and a second rotatable ball 32 disposed in a middle-sized cell space 42 has an intermediate degree of rotation, while a third rotatable ball 33 disposed in the smallest cell space 43 has the smallest degree of rotation.

Accordingly, even though the magnitude of voltage applied to each of the rotatable balls 31, 32 and 33 is the same, a wide range of contrast levels may be displayed.

By the use of the above-described features, a single cell space may form a single pixel, or a plurality of cell spaces may form a single pixel. The number of cell spaces required to form a single pixel is not particularly limited.

For example, three cell spaces may form a single pixel. Since each of the cell spaces constituting a single pixel has a different size, when the same magnitude of voltage is applied, the respective rotation angles of the rotatable balls disposed in the respective cell spaces are different.

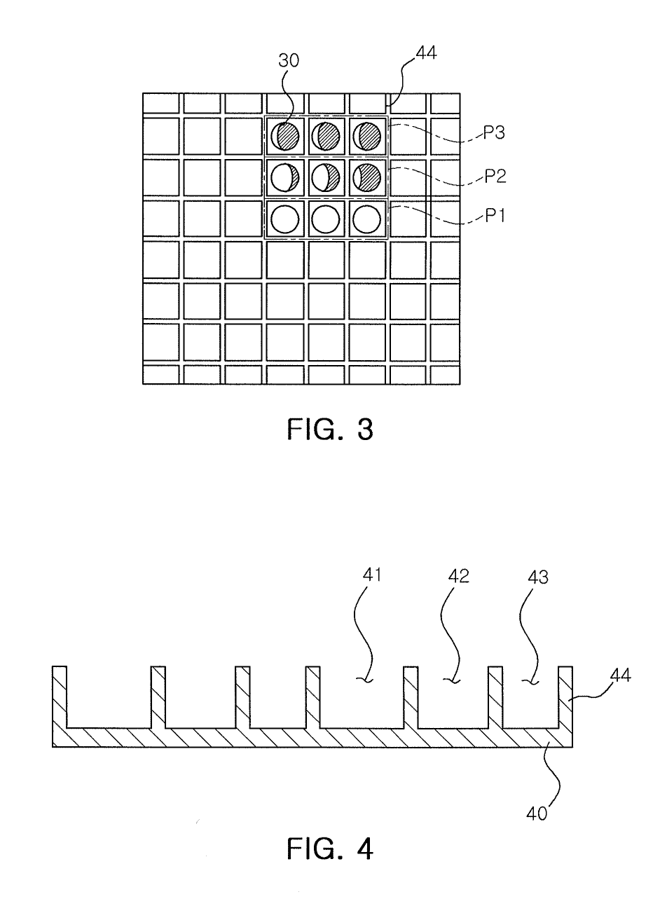

As shown in FIG. 3, three cell spaces form a single pixel P1, P2 or P3. Here, the largest magnitude of voltage allowing three rotatable balls to rotate at 180° is applied to a first pixel P1, whereby a color having a high level of contrast, i.e. white, is realized.

An intermediate magnitude of voltage is applied to a second pixel P2 to thereby allow respective rotation angles of the rotatable balls disposed in respective cell spaces to be different, whereby an intermediate level of contrast is realized.

The smallest magnitude of voltage is applied to a third pixel P3 to thereby allow the rotation angles of the rotatable balls disposed in respective cell spaces to be smaller, whereby a color having a low level of contrast is realized.

In this manner, two or more differently sized cell spaces having two or more rotatable balls disposed therein may form a single pixel, and the voltage levels applied to each pixel may be controlled to thereby realize a wide range of contrast levels.

Hereinafter, a method of manufacturing an electronic paper display device according to an exemplary embodiment of the invention will be described in detail.

FIGS. 4 through 6 are cross-sectional views illustrating manufacturing processes of an electronic paper display device according to an exemplary embodiment of the invention.

First of all, a first substrate 40 is prepared by using a light transmitting material. On the first substrate 40, partitions 44 are formed such that a space on the first substrate 40 is divided into a plurality of cell spaces 41, 42 and 43. Here, the partitions 44 may be formed with differing gaps therebetween in order to allow the cell spaces to be formed to have different sizes. Here, the first and second substrates 10 and 40 in the electronic paper display device of FIG. 1 are respectively depicted as the second and first substrates 10 and 40 in the electronic paper display device of FIGS. 4 through 6.

As shown in FIG. 4, the first substrate 40 and the partitions 44 may be formed to be integrated.

For example, an implanting method using a stamp may be employed.

More specifically, after a resin layer is formed to have a predetermined thickness, the resin layer is squeezed with a stamp having embossed and depressed patterns, thereby forming a first substrate having a plurality of partitions. According to embossed and depressed patterns of the stamp, the partitions and the cell spaces divided by the partitions are formed. Here, the embossed and depressed patterns may be adjusted to thereby adjust the gaps between the partitions and the shapes and sizes of the cell spaces.

Also, as a method of forming partitions allowing a plurality of cell spaces to be formed on a first substrate, laser patterning, photolithography, etching or the like may be used.

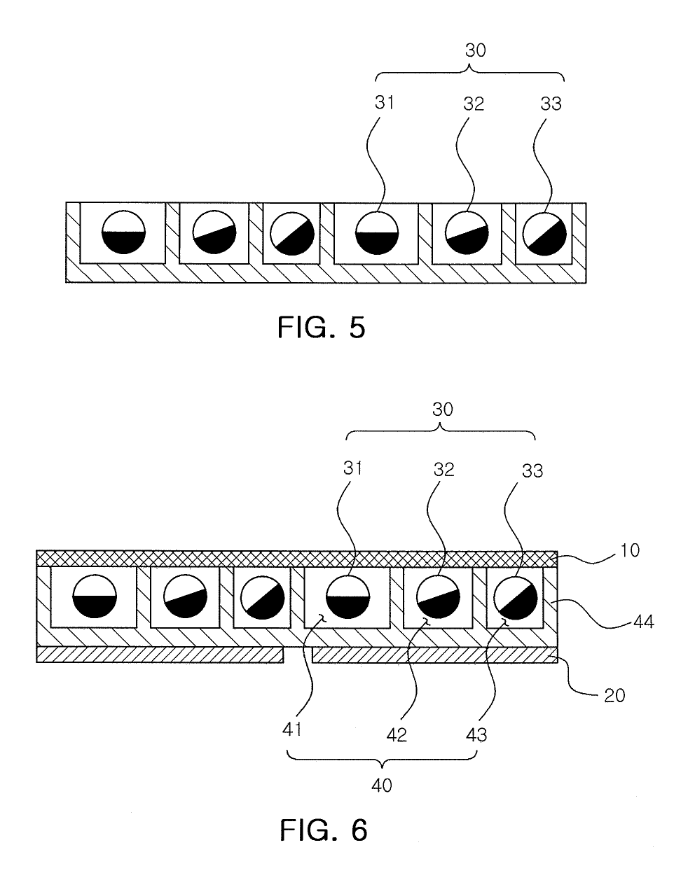

Next, as shown in FIG. 5, the plurality of cell spaces 41, 42 and 43 formed on the first substrate 40 have rotatable balls 31, 32 and 33 having electrical or optical anisotropy disposed therein.

The rotatable balls may be injected into the cell spaces by the use of a squeegee. Such a structure allowing the rotatable balls to be disposed in the cell spaces 41, 42 and 43 formed by the partitions 44 may lead to a low possibility of the presence of rotatable balls positioned in locations other than cell spaces, such as partitions.

Then, as shown in FIG. 6, the rotatable balls 31, 32 and 33 provided on the first substrate 40 are covered with the second substrate 10. Here, the second substrate 10 may have a second electrode (not shown) formed thereon.

Also, a first electrode 20 may be formed on the first substrate 40 to face the second electrode. Here, the first and second electrodes in the electronic paper display device of FIG. 1 are respectively depicted as the second and first electrodes in the electronic paper display device of FIGS. 4 through 6.

As set forth above, according to exemplary embodiments of the invention, there is provided an electronic paper display device having differently sized cell spaces where rotatable balls are disposed. When the same magnitude of voltage is applied to the rotatable balls disposed in the differently sized cell spaces, respective rotation angles of the rotatable balls become different, and accordingly a wide range of contrast levels is displayed.

Also, when two or more differently sized cell spaces having two or more rotatable balls disposed therein form a single pixel, a wide range of contrast levels is displayed by adjusting voltage levels applied to each pixel.

Furthermore, allowing rotatable balls to be disposed in the cell spaces formed by partitions results in a low possibility of the presence of rotatable balls positioned in locations other than cell spaces, such as partitions. Accordingly, stains or spots may not occur on a display, whereby the excellent stability and uniformity of an image are achieved.

While the present invention has been shown and described in connection with the exemplary embodiments, it will be apparent to those skilled in the art that modifications and variations can be made without departing from the spirit and scope of the invention as defined by the appended claims.

What is claimed is:

1. An electronic paper display device comprising:
a first substrate formed of a light transmitting material;
a second substrate disposed to face the first substrate having a predetermined gap therebetween;
at least one or more rotatable balls disposed between the first and second substrates and having electrical and optical anisotropy; and
partitions dividing a space between the first and second substrates into a plurality of cell spaces accommodating the rotatable balls,
wherein the partitions are disposed to be spaced apart from each other with differing gaps therebetween in order to allow the cell spaces to have different sizes.

2. The electronic paper display device of claim 1, wherein the cell spaces have a shape of a polyhedron, a sphere, or a cylinder.

3. The electronic paper display device of claim 1, wherein the first and second substrates have first and second electrodes formed thereon in order to apply voltage to the rotatable balls.

4. The electronic paper display device of claim 1, wherein the partitions are integrated with the second substrate.

5. The electronic paper display device of claim 1, wherein the rotatable balls have two display areas having different colors and different electrical charge properties.

6. The electronic paper display device of claim 1, wherein the rotatable balls have a shape of a sphere, an oval-shaped sphere or a cylinder.

7. The electronic paper display device of claim 1, wherein the cell spaces are filled with dielectric liquid.

8. The electronic paper display device of claim 1, wherein two or more of the cell spaces having different sizes are repeatedly formed.

9. The electronic paper display device of claim 1, wherein two or more of the cell spaces having different sizes and two or more of the rotatable balls disposed therein form a single pixel.

10. A method of manufacturing an electronic paper display device, the method comprising:
preparing a first substrate formed of a light transmitting material;
forming partitions dividing a space on the first substrate into a plurality of cell spaces and having differing gaps therebetween in order to allow the cell spaces to be formed to have different sizes;
disposing rotatable balls in the respective cell spaces, the cell spaces having electrical and optical anisotropy; and
attaching a second substrate in order to cover the rotatable balls provided on the first substrate.

11. The method of claim 10, wherein the partitions are integrated with the first substrate.

12. The method of claim 10, wherein the partitions are formed by implanting, laser patterning, photolithography, or etching.

13. The method of claim 10, further comprising forming first and second electrodes on the first and second substrates.
